(19) United States
(12) Patent Application Publication
(10) Pub. No.: US 2013/0084978 A1
(43) Pub. Date: Apr. 4, 2013

(54) System and Method of Providing a Virtual Environment to Users with Static Avatars and Chat Bubbles

(71) Applicant: Evgeny Olomskiy, Vladivostok (RU)

(72) Inventor: Evgeny Olomskiy, Vladivostok (RU)

(73) Assignee: KamaGames Ltd., Limassol (CY)

(21) Appl. No.: 13/252,056

(22) Filed: Oct. 3, 2011

(51) Int. Cl. A63F 13/00

(52) U.S. Cl. 463/31

(57) ABSTRACT

A virtual game environment may be provided to users. In views of the virtual game environment, avatars representing users may remain static (or relatively static) as a game is being played by the users in the virtual game environment. Nevertheless, communications between the users may be presented in the views within chat bubbles appearing to emanate from the appropriate avatars. This may enhance a level of engagement and/or immersion of the users in spite of the visually static nature of the avatars.

### FIELD

The disclosure relates to a system and method or providing a virtual game environment to users in which avatars remain substantially visually static during game-play, and in which user communications may be represented in

### BACKGROUND

Virtual environments used to enable users to participate in games are known. In some of these virtual environments, avatars representing the users may be visually static during game-play. For example, virtual environments supporting card and/or board games may represent avatars in a relatively static manner.

In such virtual environments, users may be able to communicate, or “chat”, with each other. Traditionally, the user communications may be presented to the users in a separate chat window that displays the communications persistently, and in the temporal order in which they were submitted by the users. As a communication is submitted, it is added to the log in the chat window, along with an identification of the user that submitted the communication.

### SUMMARY

One aspect of the disclosure relates to a system and method for providing a virtual game environment to users. In views of the virtual game environment, avatars representing users may remain static (or relatively static) as a game is being played by the users in the virtual game environment. Nevertheless, communications between the users may be presented in the views within chat bubbles appearing to emanate from the appropriate avatars. This may enhance a level of engagement and/or immersion of the users in spite of the visually static nature of the avatars.

In some implementations, the system may include a server and client computing platforms that operate in a server/client configuration. Views of the virtual game environment may be presented to the users on the client computing platforms, and the users may be able to interact with the virtual game environment and/or participate in the game through inputs to the client computing platforms. The server may be configured to execute one or more of an environment module, a game module, a communication module, and/or other modules.

The environment module may be configured to determine view information for transmissions to client computing platforms associated with users that facilitate presentation of views of a game environment to the users on the client computing platforms. The game environment may be common among the users. The individual users may be represented in the game environment by avatars located at fixed positions in the views of the game environment. The users may comprise a first user represented by a first avatar, a second user represented by a second avatar, and/or other users.

The game module may be configured to manage a game being played by the users within the game environment. Managing the game may include one or more of determining score, assessing success and/or failure (e.g., of individual actions, sets, of actions, matches, game events within an individual match, and/or other episodes), determining random or pseudo-random game parameters (e.g., card value during ordering and/or distribution, dice values, battle multipliers, and/or other parameters), and/or other game management functions.

The communication module may be configured to receive communication inputs from the users represented in the game environment by the avatars. The communication inputs may include content to be presented to the users within the views of the game environment. The content may include one or more of text, images, video, and/or other content. The communication inputs may be input by the users via the client computing platforms.

The environment module may be further configured such that responsive to reception of a communication input from the first user, a chat bubble associated with the first avatar having therein the text from the communication input of the first user may be presented in the views of the virtual game environment. The chat bubble may remain visible in the view of the game temporarily. The chat bubble may be superimposed over a portion of the views. This may include a portion of the views that includes a game field in which the game being played is presented.

Responsive to reception of a communication input from the second user while the first chat bubble is present in the views of the virtual game environment, a second chat bubble may be presented in the views of the virtual game environment with the content therein from the communication input from the second user. In the views of the virtual game environment, there may be no indication given as to which of the first chat bubble or the second chat bubble appeared first, other than the first chat bubble disappearing before the second chat bubble disappears (e.g., because the first chat bubble appeared first).

While the lack of temporal indicators and/or the obscuring of other fields and/or elements within the views may appear to be drawbacks in presenting user communication in the chat bubbles, this may not be the case. The representation of communication between the users using chat bubbles (e.g., rather than a conventional chat log) may enhance the sense of engagement and/or immersion of the users, even though the avatars may be static or substantially static in view 30. For example, this presentation of user communications may seem more conversational to the users, and/or may more closely mimic real world conversations.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide a virtual game environment to users.

FIG. 2 illustrates a view of a virtual game environment.

FIG. 3 illustrates a view of a virtual game environment.

FIG. 4 illustrates a method of providing a virtual game environment to users.

### DETAILED DESCRIPTION

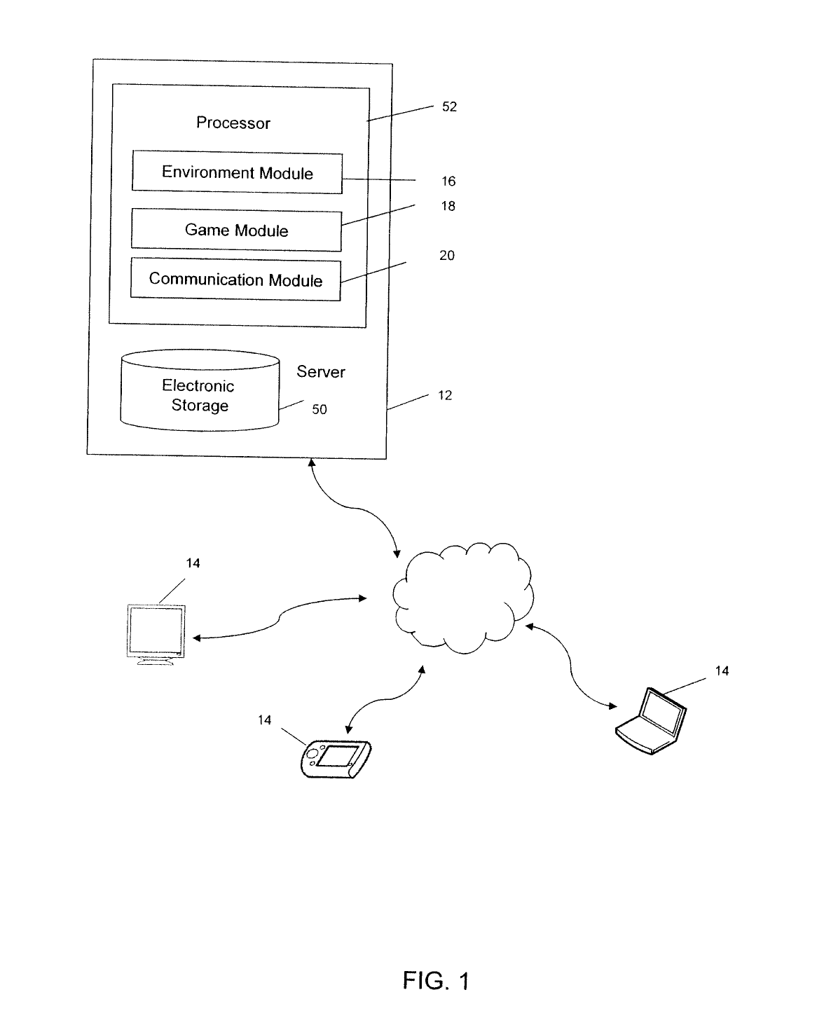

FIG. 1 illustrates a system 10 configured to provide a virtual game environment to users. The system 10 may be configured such that the users participate in a game within the virtual game environment. While views of the game environment provided to users may be relatively static visually, communication between the users may be represented using chat bubbles, instead of via a conventional chat log. This interface may enhance engagement and/or immersion of the users while still maintaining the relatively low processing, storage, and/or communication bandwidth costs of a relatively visually static environment. Providing the virtual game environment may include hosting the virtual game environment over a network.

In some implementations, system 10 may include a server 12. The server 12 may be configured to communicate with one or more client computing platforms 14 according to a client/server architecture. The users may access system 10 and/or the virtual game environment via client computing platforms 14.

The server 12 may be configured to execute one or more computer program modules. The computer program modules may include one or more of an environment module 16, a game module 18, a communication module 20, and/or other modules.

The environment module 16 may be configured to provide one or more virtual game environments to users via client computing platforms 14. As used herein, a “virtual environment” may include a virtual space, one or more interactive, electronic social media, and/or other virtual environments. A virtual game environment may refer to a virtual environment in which a game is being played that involves a plurality of users. Providing a virtual environment to users may include executing one or more instances of a virtual environment, determining view information representing the virtual environment (e.g., from the instance(s)) for the users (e.g., individually and/or collectively), transmitting the view information to the client computing platforms 14 associated with the users to facilitate views of the virtual environment being presented to the users, and/or other activities.

A virtual space may comprise a simulated space that is accessible by users via clients (e.g., client computing platforms 14) that present the views of the virtual space to a user. The simulated space may have a simulated physical layout, express ongoing real-time interaction by one or more users, and/or be constrained by simulated physics that governs interactions between virtual objects in the simulated space. In some instances, the simulated physical layout may be a 2-dimensional layout. In other instances, the simulated physical layout may be a 3-dimensional layout.

The environment module 16 may be configured to express the virtual space in a relatively limited manner. For example, views of the virtual space presented to the users may be selected from a limited set of graphics depicting an event in a given place within the virtual space. The views may include additional content (e.g., text, audio, pre-stored video content, movable icons, avatars, and/or other content) that describes particulars of the current state of the space, beyond the relatively generic graphics. For example, a view of the virtual space may depict a card table and/or a non-player character that are static (or change relatively little) visually in views of virtual space. Icons representing game components (e.g., game pieces, playing cards, dice, and/or other game components) may change and/or move within the views of the virtual space to depict a game being played within the virtual space. Such limited representation of the virtual space may reduce the cost of hosting the virtual game environment in terms of processing, storage, communication bandwidth, and/or other computing resource (e.g., on server 12 and/or client computing platforms 14). Other expressions of individual places within the virtual space are contemplated.

Within the instance(s) of the virtual space (or other virtual environment) executed by environment module 16, users may control avatars to interact with the virtual space and/or each other. As used herein, the term “user character” may refer to an object (or group of objects) present in the virtual space that represents an individual user. The avatar may be controlled by the user with which it is associated. While a game is being played within the virtual space, the avatars may be positioned at fixed locations within the virtual space and/or views thereof. This may reduce the cost of providing the virtual game environment to the users, and may be consistent with the mechanic of the game being played. The avatar representing a given user may be created and/or customized by the given user. The user may have an “inventory” of virtual goods and/or currency that the user can use (e.g., by manipulation of an avatar or other user controlled element, and/or other items), display, gift, and/or otherwise interact with in the virtual space.

The users may participate in the virtual space by controlling one or more of the available user controlled elements in the virtual space (e.g., game elements, avatars, and/or other elements). Control may be exercised through control inputs and/or commands input by the users through client computing platforms 14.

Interactive, electronic social media may include one or more of a social network, a virtual space, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. As was the case with virtual spaces, in some implementations, users may be represented within interactive, electronic social media by avatars. An avatar representing a given user may be presented in views of the interactive, electronic social media as being associated with content that may be provided by the given user, directed the given user, related to the given user, and/or associated with the given user in other ways. Some non-limiting specific examples of interactive, electronic social media may include the micro-blogging service provided by Twitter™, the social network provided by Facebook™, the social network provided by MySpace™, the social network provided by Foursquare®, the virtual world provided by SecondLife®, the massively multi-player online game provided by World of Warcraft®, the file sharing service provided by Flickr®, Blogger, YouTube, PlayStation® Home, Xbox® Live, and/or other interactive electronic social media.

The game module 18 may be configured to manage the game being played by the users within the virtual game environment. Managing the game may include one or more of determining score, assessing success and/or failure (e.g., of individual actions, sets, of actions, matches, game events within an individual match, and/or other episodes), determining random or pseudo-random game parameters (e.g., card value during ordering and/or distribution, dice values, battle multipliers, and/or other parameters), and/or other game management functions. Managing the game may include accepting input in the form of user selections and/or actions (e.g., input at client computing platforms 14), output from one or more random (or pseudo-random) number generators, rules and/or settings governing one or more game mechanics of the game, and/or other inputs. Managing the game may include determining outputs in the form scores (e.g., of individual actions, sets, of actions, matches, game events within an individual match, and/or other episodes), winners and/or losers, required actions to be performed by the users, and/or other outputs.

By way of non-limiting example, in some implementations, game module 18 may be configured to manage a game of poker being played within the virtual game environment. Such management may require one or more of determining blind size and/or assignment, determining card value and/or distribution, managing the pot (e.g., receiving bets, distributing winnings, and/or other management), determining hand winners, maintaining user chip stacks, maintaining user bank rolls, and/or other management tasks. As another non-limiting example, game module 18 may be configured to manage a game of backgammon. Such management may require one or more of managing checker position, determining dice value, determining doubling cube value, determining score, determining a winner, and/or other management tasks. Implementations in which game module 18 manages other turn-based games are contemplated. Such games may be based on real world board and/or card games, and/or games that have not previously been implemented as real world games.

It will be appreciated that the description herein of environment module 16 providing a virtual game environment to a set of users in which a game is being played by the set of users is not intended to be limiting. For example, environment module 16 may be configured to provide a plurality of different virtual game environments to a plurality of different sets of users. The individual sets of users may be participating in different instances of the game within the individual virtual game environments. The concepts described herein with respect to the individual virtual game environment and game should be extendible to implementations in which a plurality of different virtual game environments are being used to conduct a plurality of different instances of the game (e.g., between different sets of users).

The communication module 20 may be configured to receive communication inputs from the users. The communication inputs may include communications to be conveyed within the virtual game environment to the other users participating in the virtual game environment. The communication inputs may include content. The content may include one or more of text, an image, video, and/or other content. For example, a user may enter a communication input to system 10 by inputting text to the client computing platform 14 corresponding to the user. The communication input (with the input text) may be communicated to communication module 20. Conveying the content from a communication input to other users within the virtual game environment may include presenting the content in the views of the virtual game environment that are determined by environment module 16 for the other users.

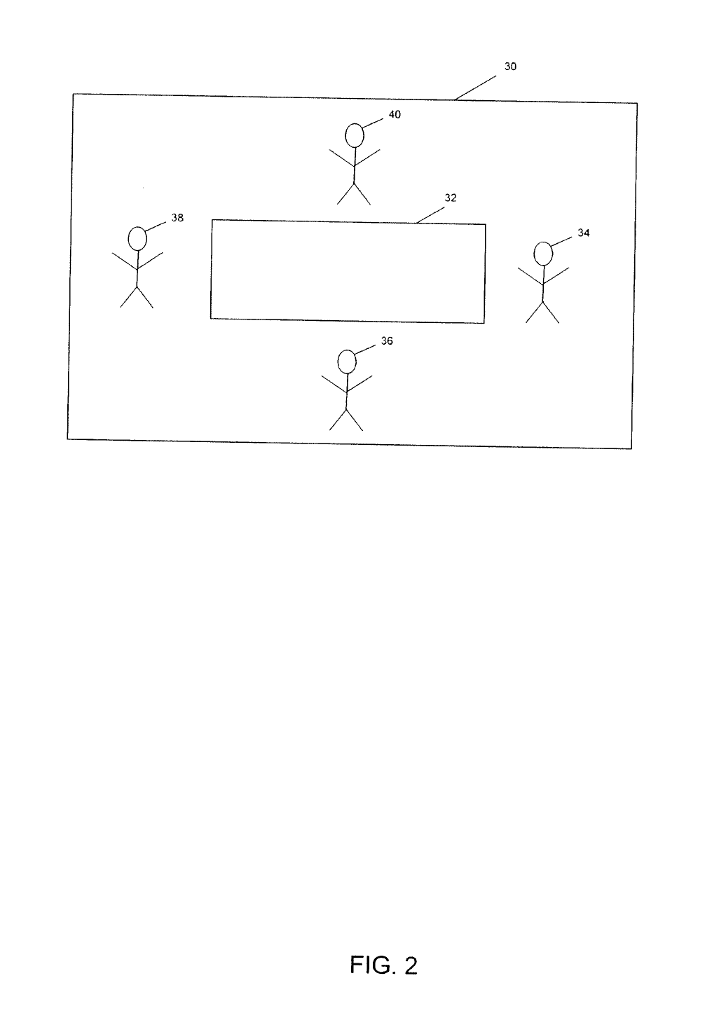

By way of illustration, FIG. 2 illustrates a view 30 of a virtual game environment. The view 30 may include a game field 32, a first avatar 34, a second avatar 36, a third avatar 38, a fourth avatar 40, and/or other fields or features. The game field 32 may be configured to present information to the user viewing view 30 of the game being played in the virtual game environment. For example, if the game is a board game or a card game, the game board and/or the cards may be represented in game field 32. In some implementations, game field 32 may be represented as a table on which the board and/or cards sit.

The avatars 34, 36, 38, and/or 40 may represent a first user, a second user, a third user, and/or a fourth user, respectively within view 30. In some implementations, avatars 34, 36, 38, and/or 40 may be located at fixed, or substantially fixed, positions in view 30 during the game (e.g., around game field 32). This may reduce the cost associated with determining view 30 and/or providing view 30 to the user.

Traditionally, users may be able to communicate with each other within views of virtual game environments similar to or the same as view 30 through displays of text (and/or other content) that have been received from the users. However, the display of such text and/or other content has been made in a designated field set apart from game field 32 and/or avatars 34, 36, 38, and/or 40. In the designated field, the text and/or other content would be represented in the form of a conventional chat log in which a given communication identifies the user that submitted the content and then presents the content. As further communications are presented, they are added to the designated field to provide a log of the communication between the users in an ongoing manner.

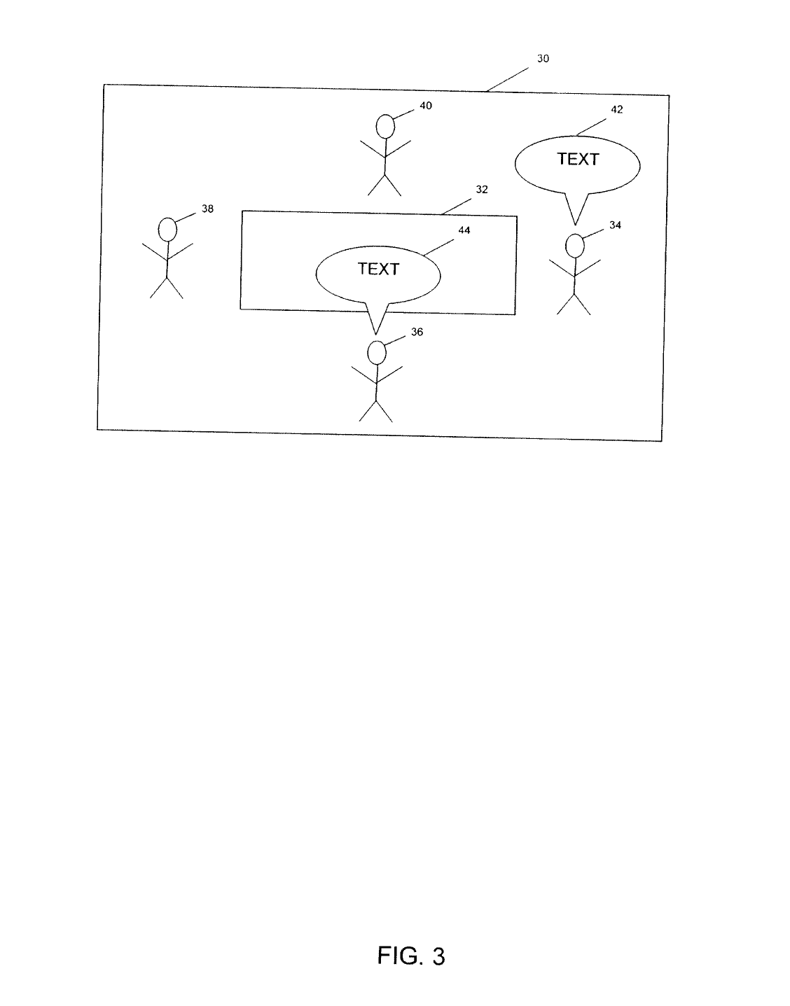

By contrast, view 30 is configured such that despite the static positions of avatars 34, 36, 38, and 40 within view 30, content from a communication input may be displayed in a chat bubble emanating from the avatar associated with the user that submitted the content. By way of illustration, FIG. 3 depicts an example in which a first user associated with first avatar 34 has submitted a communication input having text therein. The text from the communication input from the first user may be presented in view 30 within a chat bubble 42. The chat bubble 42 may be depicted as emanating from first avatar 34. The chat bubble 42 may be present in view 30 for some period of time. The period of time may be a predetermined period of time. The period of time may be common among all of the users that receive a view of the virtual game environment, and/or the period of time may differ between different views (e.g., based on user preferences, and/or other parameters).

While chat bubble 42 is present in view 30, responsive to the second user submitting a communication input having text therein, the text submitted by the second user may be presented in view 30 in a chat bubble 44 associated with second avatar 36. As such, chat bubbles 42 and 44 may both be present in view 30 for a period of time (e.g., until chat bubble 42 is longer present). While chat bubbles 42 and 44 are present in view 30, no indication of which chat bubble appeared first may be given.

As can be seen in FIG. 3, depending on the arrangement of avatars 34, 36, 38, and/or 40 and game field 32 in view 30, a given chat bubble, such as chat bubble 44 may be superimposed over at least a portion of game field 32. The portion of game field 32 over which chat bubble 44 is superimposed may be visible, obscured in some way, or blocked entirely through chat bubble 44.

While the lack of temporal indicators and/or the obscuring of other fields and/or elements within view 30 may appear to be drawbacks in presenting user communication in chat bubbles 42 and/or 44, this may not be the case. The representation of communication between the users using chat bubbles 42 and/or 44 may enhance the sense of engagement and/or immersion of the users, even though avatars 34, 36, 38, and/or 40 may be static or substantially static in view 30. For example, this presentation of user communications may seem more conversational to the users, and/or may more closely mimic real world conversations.

Turning back to FIG. 1, in some implementations, 12 server and client computing platforms may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server 12 and/or client computing platforms 14.

A given client computing platform 14 may include one or more processors, and electronic display, a control interface, and/or other components. The one or more processors may be configured to execute computer program modules. The computer program modules may be configured to enable or user associated with the given client computing platform 14 to interface with system 10, and/or provide other functionality attributed herein to client computing platforms 14. For example, the computer program modules may include a view module configured to receive view information from server 12 (e.g., generated by environment module 16), and to present a view of the virtual game environment (e.g., as described above) based on the received view information. This may facilitate participation by the user of the given client computing platform 14 in the game taking place in the virtual game environment. By way of non-limiting example, the given client computing platform 14 may include one or more of a desktop computer, a laptop computer, a handheld computer, a tablet computing platform, a NetBook, a Smartphone, a gaming console, and/or other computing platforms.

The server 12 may include electronic storage 50, one or more processors 52, and/or other components. The server 12 may include communication lines, or ports to enable the exchange of information with a network and/or other computing platforms. Illustration of server 12 in FIG. 1 is not intended to be limiting. The server 12 may include a plurality of hardware, software, and/or firmware components operating together to provide the functionality attributed herein to server 12. For example, server 12 may be implemented “in the cloud” by a plurality of computing platforms operating together as server 12.

Electronic storage 50 may comprise electronic storage media that electronically stores information. The electronic storage media of electronic storage 50 may include one or both of system storage that is provided integrally (i.e., substantially non-removable) with server 50 and/or removable storage that is removably connectable to server 50 via, for example, a port (e.g., a USB port, a firewire port, etc.) or a drive (e.g., a disk drive, etc.). Electronic storage 50 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 50 may include one or more virtual storage resources (e.g., cloud storage, a virtual private network, and/or other virtual storage resources). Electronic storage 50 may store software algorithms, information determined by processor 52, information received from server 12, information received from client computing platforms 14, and/or other information that enables server 12 to function as described herein.

Processor(s) 52 is configured to provide information processing capabilities in server 12. As such, processor 52 may include one or more of a digital processor, an analog processor, a digital circuit designed to process information, an analog circuit designed to process information, a state machine, and/or other mechanisms for electronically processing information. Although processor 52 is shown in FIG. 1 as a single entity, this is for illustrative purposes only. In some implementations, processor 52 may include a plurality of processing units. These processing units may be physically located within the same device, or processor 52 may represent processing functionality of a plurality of devices operating in coordination. The processor 52 may be configured to execute modules 16, 18, and/or 20. Processor 52 may be configured to execute modules 16, 18, and/or 20 by software; hardware; firmware; some combination of software, hardware, and/or firmware; and/or other mechanisms for configuring processing capabilities on processor 52.

It should be appreciated that although modules 16, 18, and/or 20 are illustrated in FIG. 1 as being co-located within a single processing unit, in implementations in which processor 52 includes multiple processing units, one or more of modules 16, 18, and/or 20 may be located remotely from the other modules. As a non-limiting example, some or all of the functionality attributed to modules 16, 18, 20, and/or 22 may be provided “in the cloud” by a plurality of processors connected through a network. The description of the functionality provided by the different modules 16, 18, and/or 20 herein is for illustrative purposes, and is not intended to be limiting, as any of modules 16, 18, and/or 20 may provide more or less functionality than is described. For example, one or more of modules 16, 18, and/or 20 may be eliminated, and some or all of its functionality may be provided by other ones of modules 16, 18, and/or 20. As another example, processor 52 may be configured to execute one or more additional modules that may perform some or all of the functionality attributed below to one of modules 16, 18, and/or 20.

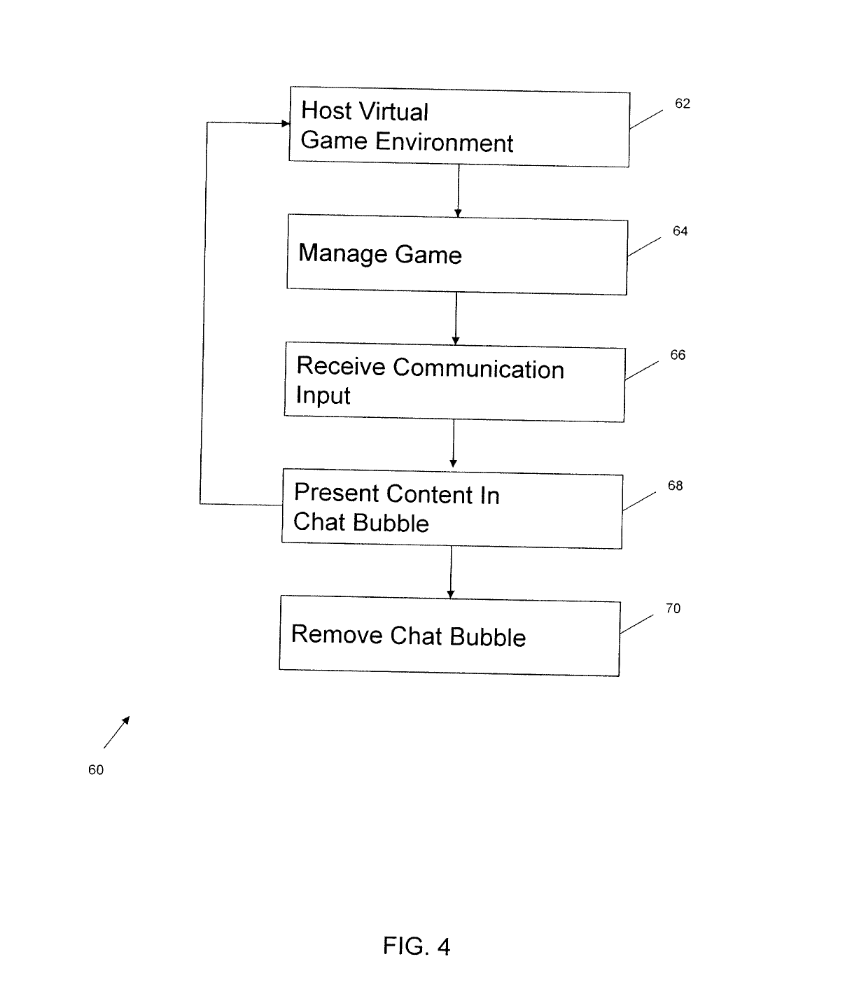

FIG. 4 illustrates a method 60 of providing a virtual game environment to client computing devices for interaction by users. The operations of method 60 presented below are intended to be illustrative. In some embodiments, method 60 may be accomplished with one or more additional operations not described, and/or without one or more of the operations discussed. Additionally, the order in which the operations of method 60 are illustrated in FIG. 4 and described below is not intended to be limiting.

In some embodiments, method 60 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 60 in response to instructions stored electronically on an electronic storage medium. The one or more processing devices may include one or more devices configured through hardware, firmware, and/or software to be specifically designed for execution of one or more of the operations of method 60.

At an operation 62, the virtual game environment may be hosted. Hosting the virtual game environment may include determining, and/or sending to client computing platforms, view information defining views of the virtual game environment for display on the client computing platform. Users may be represented by avatars within the views. The avatars may include a first avatar associated with a first user. In some implementations, operation 62 may be performed by an environment module similar to or the same as environment module 16 (shown in FIG. 1 and described herein).

At an operation 64, a game being played by users within the virtual game environment may be managed. In some implementations, operation 64 may be performed by a game module similar to or the same as game module 18 (shown in FIG. 1 and described herein).

At an operation 66, a communication input may be received from the first user. The communication input may include content, such as text, to be communicated with the other users. In some implementations, operation 66 may be performed by a communication module similar to or the same as communication module 20 (shown in FIG. 1 and described herein).

At an operation 68, the content from the communication input may be represented in view information defining the views of the virtual game environment as a chat bubble emanating from the first avatar. In some implementations, operation 68 may be performed by the environment module.

At an operation 70, the representation of the chat bubble may be removed from the view information defining the views after some period of time has passed. In some implementations, operation 70 may be performed by the environment module.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to provide a virtual game environment to users, the system comprising:
one or more processors configured to execute computer program modules comprising:
an environment module configured to determine view information for transmissions to client computing platforms associated with users that facilitate presentation of views of a game environment to the users on the client computing platforms, wherein the game environment is common among the users, wherein the individual users are represented in the game environment by avatars located at fixed positions in the views of the game environment, and wherein the users comprise a first user represented by a first avatar;
a game module configured to manage a game being played by the users within the game environment; and
a communication module configured to receive communication inputs from the users represented in the game environment by the avatars, wherein the communication inputs include text to be presented to the users within the views of the game environment,
wherein the environment module is configured such that responsive to reception of a communication input from the first user, the environment module presents, in the views of the game environment, a chat bubble associated with the first avatar having therein the text from the communication input of the first user.

2. The system of claim 1, wherein the game module is configured such that game is a turn-based game.

3. The system of claim 2, wherein the game module is configured such that the game is a card game or a board game.

4. The system of claim 2, wherein the game module is configured such that the game is poker, and wherein the environment module is configured such that the avatars are arranged in views of the game environment in designated locations around a representation of a card table.

5. The system of claim 1, wherein the environment module is configured such that the chat bubble remains visible in the views of the game environment temporarily.

6. The system of claim 1, wherein the users further comprise a second user represented by a second avatar, and wherein the environment module is configured such that responsive to reception of a communication input from the second user, the environment module presents, in the views of the game environment, a chat bubble associated with the second avatar having therein the text from the communication input of the second user.

7. The system of claim 6, wherein responsive to the communication input from the second user being received while the chat bubble associated with the first avatar is being presented, the chat bubbles associated with the first avatar and the second avatar are presented in the views of the game environment at the same time.

8. The system of claim 1, wherein entering the communication inputs is the only input available to the users, outside of direct participation in the game, that impacts the views of the game environment.

9. The system of claim 8, wherein direct participation in the game comprises taking some action that impacts an outcome of the game.

10. A client computing platform configured to present a view of a virtual game environment to a first user, the client computing platform comprising:
an electronic display;
a control interface;
one or more processors configured to execute computer program modules comprising:
a view module configured to receive view information from a server, and generate a view of a game environment for presentation to a user via the electronic display,
wherein the game environment is common among the user and a set of other users to facilitate playing of a group game by the user and the set of other users within the game environment,
wherein the individual users are represented in view of the game environment by avatars,
wherein the set of other users comprise a first user represented by a first avatar,
wherein the view module is further configured such that the view of the game environment depicts chat bubbles having therein text included in communication inputs from the other users such that such that responsive to the first user inputting a communication input, the view of the game environment includes a chat bubble associated with the first avatar having therein the text from the communication input of the first user.

11. The client computing platform of claim 10, wherein the game is a turn-based game.

12. The client computing platform of claim 11, wherein the game is a card game or a board game.

13. The client computing platform of claim 11, wherein the game is poker, and wherein the avatars are arranged in the view of the game environment in designated locations around a representation of a card table.

14. The client computing platform of claim 10, wherein the view module is configured such that the chat bubble remains visible in the view of the game environment temporarily.

15. The client computing platform of claim 10, wherein the other users further comprise a second user represented by a second avatar, and wherein the view module is configured such that responsive to the second user inputting a communication input, the view module presents, in the view of the game environment, a chat bubble associated with the second avatar having therein the text from the communication input of the second user.

16. The client computing platform of claim 15, wherein responsive to the communication input from the second user being received while the chat bubble associated with the first avatar is being presented, the chat bubbles associated with the first avatar and the second avatar are presented in the views of the game environment at the same time.

17. The client computing platform of claim 10, wherein entering the communication inputs is the only input available to the users, outside of direct participation in the game, that impacts the view of the game environment.

18. The client computing platform of claim 17, wherein direct participation in the game comprises taking some action that impacts an outcome of the game.
